(19) United States
(12) Patent Application Publication
(10) Pub. No.: US 2005/0106302 A1
(43) Pub. Date: May 19, 2005

(54) System and method for manufacturing a clarified butter product

(76) Inventor: Levi Gil Shoshan, Wellington, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/936,869

(22) Filed: Sep. 9, 2004

Related U.S. Application Data
(60) Provisional application No. 60/501,870, filed on Sep. 10, 2003.

(51) Int. Cl. A23L 1/05

(52) U.S. Cl. 426/581

(57) ABSTRACT

Butter has long been used to enhance flavor and prevent burning of food during cooking. Butter, however must be kept cool to avoid spoilage by hydrolysis and microbiological action. Butter-oil, also known as clarified butter, drawn butter, and Ghee resists spoilage because it is practically anhydrous, thereby increasing the shelf-life of products made with this substance. The smoke point temperature of butter-oil is also higher than butter, making its use attractive in frying, sauteing, and preparing sauces. Cookbook recipes for making clarified butter are time-consuming and wasteful, while large commercial systems are costly. A relatively low-cost system and method for preparing clarified butter that is applicable in large or small-scale operations is described herein.

### CROSS-REFERENCE TO RELATED APPLICATIONS

This application claims the benefit of U.S. Provisional Application Ser. No. 60/501,870, filed on Sep. 10, 2003, entitled METHOD OF MANUFACTURING A CLARIFIED BUTTER PRODUCT.

### TECHNICAL FIELD OF THE INVENTION

The present invention relates to food products, particularly to shelf-stable clarified butter products and to their methods of preparation.

### BACKGROUND OF THE INVENTION

Butter is composed of about 80% milk-fat, about 17% water, about 1.5% salt, and about 1.5% non-fat milk-solids. The non-fat milk-solids include casein, milk sugar, and lactose. Butter can be prepared by churning high fat cream until the milk-fat globules, which are 2 to 9 micrometers in diameter, clump together as butter granules. The churning action breaks the phospholipid and protein membranes that normally prevent milk-fat globules from coalescing. Butter is produced by mechanically gathering and washing the butter globules and pressing them into a mass.

Butter has long been used as a spread for breads and other foods as well as in cooking for enhancement of flavor. Fine cuisines of the world are enhanced and emboldened by a wide variety of sauces. The sauces, however, are divided into a limited number of groups to which select ingredients are added for making derivatives of the final product. Generally, the groups comprise brown sauces, white sauces, tomato sauces, egg yolk and oil sauces, oil and vinegar sauces, and butter sauces. Sauces are prepared in batch quantities and held for extended periods through appropriate packaging, such as bottling, canning, and/or freezing. The butter sauces, on the other hand, have not been successfully packaged in usable, shelf-stable form without first changing composition of the butter product.

Freezing and then thawing butter sauce mixtures have been commercially marketed, but it is costly and inconvenient. Additionally, the texture and flavor of the finished sauce made from the frozen product is affected by the length of time the frozen mixture has been stored. Alternatively, shelf life of butter-derived products can be significantly extended by using a butter-based product where water and non-fat milk-solids have been removed. Products with these properties include butter-oil, Ghee, and Anhydrous butter-oil. “Clarified butter” is an alternative name for butter-oil. “Drawn butter” is an expression that is used interchangeably with “clarified butter” in cooking recipes.

High content milk-fat products have little water and minimum non-fat solid content. According to the Canadian Food Inspection System, products that are named Butter-oil and Ghee shall contain not less than 99.3% milk-fat and not more than 0.5% water. Anhydrous butter-oil shall contain not less than 99.8% milk-fat and not more than 0.1% water. Butter-oil can be substituted for butter in products not requiring refrigeration because it is practically anhydrous and therefore resists spoilage by hydrolysis and microbiological action. It is primarily composed of mixed glycerides of fatty acids and is produced by heating butter, removing the water, and removing the non-fat solid content by allowing it to settle out or removing it by centrifuge.

In addition to long shelf-life, another advantage of butter-oil over butter is the increased smoke point of 325 degrees Fahrenheit. This compares favorably with ordinary butter that has a smoke point of around 260 degrees Fahrenheit. This increased smoke point temperature is useful because the product can be used for frying, sauteing, or preparing sauces such as Bearnaise or Hollandaise with decreased concern about browning or burning. Unsalted butter should be used to manufacture clarified butter, as salt can lower the smoking point of the finished product.

Both small, kitchen-based and large, commercial manufacturing processes for preparation of clarified butter have been discussed in the literature. At the kitchen-based level, butter is gently heated in a saucepan until the butterfat separates out and forms a thick layer in the pan. Most of the milk-solids will drop to the bottom of the pan, and a layer of white foam will form on top. The cook gently removes the pan from the heat so as to avoid disturbing the layers, spoons off the top layer of foam, and carefully pours off the pure butterfat into a clean container. The milky residue from the bottom of the pan is discarded. One recipe calls for the butter-oil to be poured through cheesecloth to further aid in filtering the non-fat milk-solids. This method, while useful on a small scale, results in up to 30% waste of the butter.

Another prior art method is to melt the butter and boil it until the milk-solids coagulate and clump together at the bottom of the pan and the butterfat floats on top. If the milk proteins are permitted to harden and darken slightly, the butterfat intensifies in flavor and color and is known as ghee, which is used in Indian cooking. The smoke point of ghee is slightly higher than that of regular clarified butter.

At the commercial scale, the non-fat milk-solids can be collected by centrifuge after heating the butter. This results in a very high return of butter-oil product. Costs for centrifuge equipment tend to be significant, therefore, this method is unlikely to be used in a small-scale operation.

### SUMMARY OF THE INVENTION

The present invention presents a system and method for producing clarified butter that uses a heating and settling process. An additional step of agitating the mixture is unique to the present invention, and helps promote precipitation and settling of milk-solids on the bottom of the processing tank. A further improvement of this system over the prior-art includes incorporation of a drain valve on the lower section of the processing tank that permits water and non-fat milk-solids to be drained away prior to collection of the butter-oil. The addition of several filters of varying pore sizes, permit further purification of the butter-oil. This system offers cost and quality advantages over the prior art, and is simple enough to be used in a small-scale commercial or kitchen-based environment.

### BRIEF DESCRIPTION OF THE DRAWINGS

FIG. 1 is an illustration of the preferred embodiment of the present invention. It outlines the major components of the system, including a processing tank, a discharge valve placed low on the processing tank, a butter-oil discharge valve, an agitation mechanism, 2 filters, and a pump to facilitate butter-oil flow.

FIG. 2 is a detailed cross-section of the processing tank, indicating the water heating compartment, and the agitation mechanism of the preferred embodiment.

FIG. 3 is a diagram of the preferred embodiment of the present invention with the addition of an optional product packaging machine.

### DETAILED DESCRIPTION OF THE PREFERRED EMBODIMENT

Clarified butter is prepared from butter by removing water and nonfat elements in order to improve its storage and cooking qualities. Without the milk proteins, clarified butter can be heated to higher temperatures without browning or burning, thus it is particularly useful for gentle sauteing.

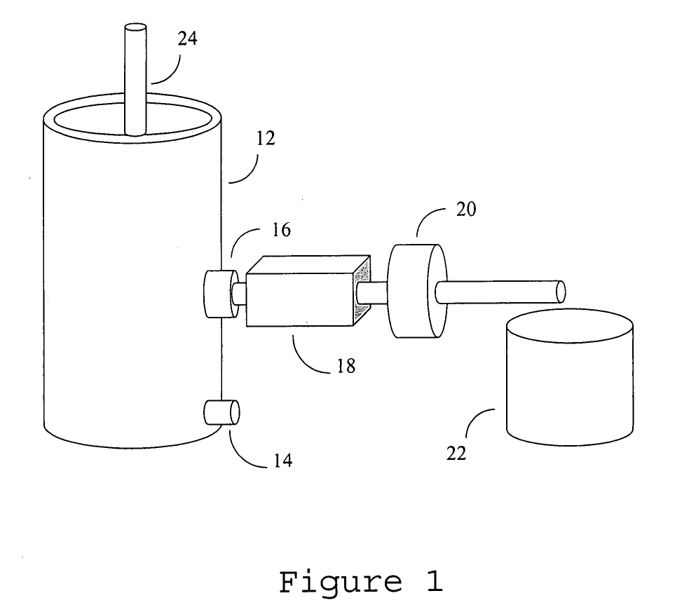

FIG. 1 illustrates the preferred embodiment of the clarified butter system. The clarified butter system includes a processing tank 12. Processing tank 12 includes a discharge valve 14 and a disk filter 16.

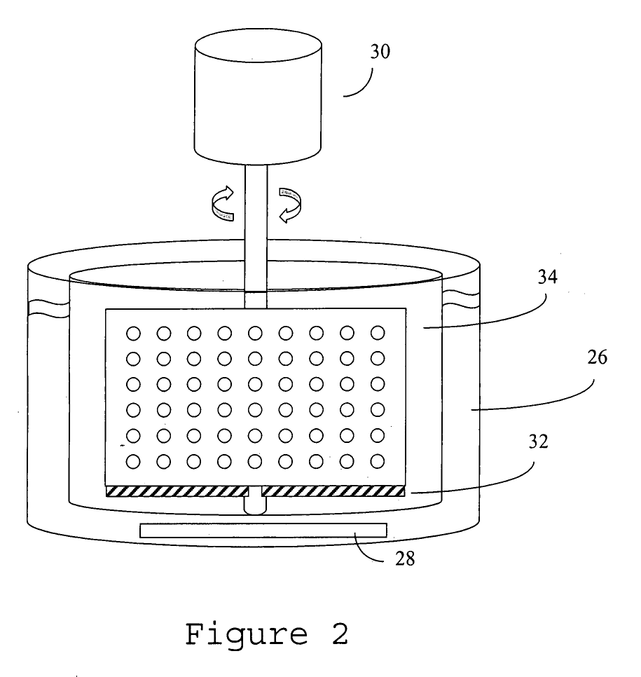

Processing tank 12 stores and heats butter that has been melted and deposited into it. The butter can be melted in a variety of ways, such as with a heated grid. In the preferred embodiment, the processing tank 12 is configured as double-walled stainless steel receptacle 26 with space between said walls for water to be heated by a resistive heating element 28 positioned therein, as shown in FIG. 2. The water is heated to around 200 degrees Fahrenheit (+/− 20 degrees), for maintaining a butter-oil target temperature of 180 degrees Fahrenheit (+/− 20 degrees). An agitation force is also applied to the butter in the tank 12. In the preferred embodiment, the force is provided by motor 30 driven stainless steel blades 32 with a single 26″ tall perforated screen 34 attached that spins in conjunction with the blades. The agitation force, which is proportional to motor speed, has been empirically determined to be most effective between 4 and 10 rotations per minute (RPM). After a period of 1½ to 3 hours, which is related to the amount of agitation and the temperature of processing tank 12, the milk-solids separate from the butter. At a butter-oil temperature of 180 degrees Fahrenheit and a motor speed of six (6) RPM, approximately two (2) hours is waited to allow precipitation of milk-solids from the butter.

A small pump (not shown) may be used to remove any milk-solids from the top of processing tank 12 and pass them to the bottom of processing tank 12 or away from the system altogether. Discharge valve 14 operates to facilitate removal of the milk-solids and water from processing tank 12. This can be aided by a pump (not shown) that assists in the disposal of the milk-solids and water.

As the butter-oil flows out of processing tank 12, it is filtered, preferably twice. The flowing butter-oil is passed through a first filter, such as disk filter 16, and then through a second filter, such as an inline filter 18. Disk filter 16 is preferably a filter having pores capable of filtering out particles that are greater than or approximately equal to 30 microns in diameter. Inline filter 18 is preferably a filter having pores capable of filtering out particles that are greater than or approximately equal to 15 microns in diameter. This filtering process provides a butter-oil that is substantially milk-solid free. An additional pump, such as pump 20, can be used to improve flow of the butter-oil from processing tank 12 through the filters.

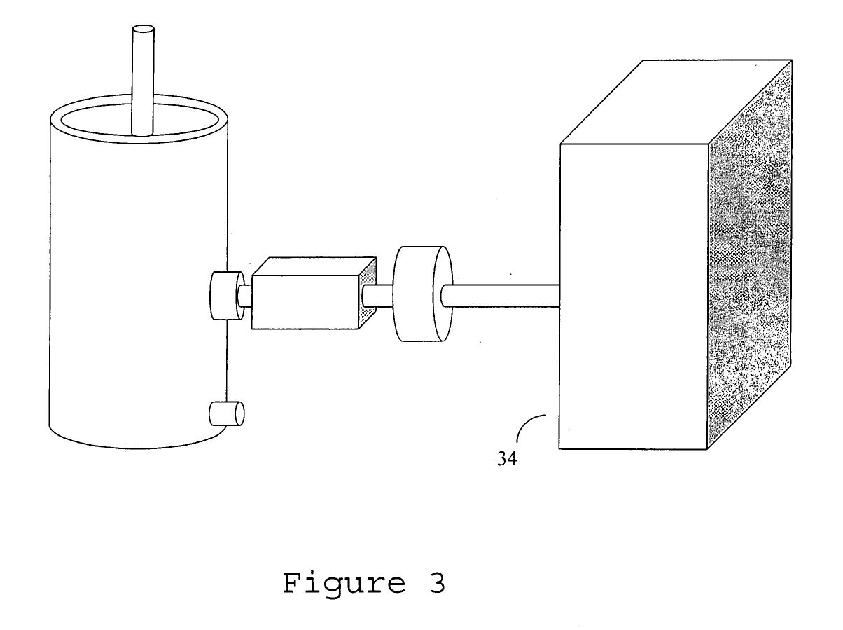

After the clarified butter product is filtered, it is pumped to a waiting container 22, as shown in FIG. 1, to be used or stored. Alternatively the product can be channeled to a packaging machine 24 as shown in FIG. 3. Packaging machine 24 forms pouches from high temperature-resistant film, for example, that function as receptacles for the clarified butter product. As the pouches are formed, they are sterilized with ultraviolet light to reduce the possibility of contamination by living microorganisms. Other sterilizing methods can be used, as are well known in the art. Once the pouches are formed, they are filled with the clarified butter product at temperatures between approximately 120° F. to 150° F., and preferably at about 140° F. and immediately sealed thereafter.

The components that makeup the present invention are readily available and relatively inexpensive, offering a clear advantage over commercial systems using centrifuges. Additionally, the present invention offers the advantage of reduced waste in comparison to the conventional cookbook recipe of pan heating butter and draining the clarified butter.

Although only a few exemplary embodiments of the present invention have been described in detail above, those skilled in the art will readily appreciate that numerous modifications are possible to the exemplary embodiments without materially departing from the novel teachings and advantages of this invention. Accordingly, all such modifications are intended to be included within the scope of this invention.

1. A butter clarification system comprising:
a processing tank for storing and processing butter, said processing tank comprising a heating capability and an agitation capability to separate a first layer of milk product, a second layer of butter-oil, a third layer of milk solids, and water from said butter;
a first discharge valve for removal of said second layer of butter-oil from said processing tank;
a second discharge valve for removal of said third layer of milk solids, and water from said processing tank; and
a first filter physically connected to said first discharge valve to remove particles from said butter-oil.

2. A butter clarification system as in claim 1, further comprising:
second filter, wherein the distal end of said first filter is connected to the proximal end of said second filter to remove additional particles from said butter-oil.

3. A butter clarification system as in claim 1:
wherein said first filter is designed to remove particles larger than about 10 microns.

4. A butter clarification system as in claim 2:
wherein said second filter is designed to remove particles smaller than said first filter is capable of removing.

5. A butter clarification system as in claim 1, wherein said agitation capability comprises a motorized stirring system.

6. A butter clarification system as in claim 2, wherein a fluid flow is increased by introduction of a fluid pump downstream of said second filter.

7. A butter clarification system as in claim 1, wherein an optional fluid pump removes said first layer of milk product from said processing tank.

8. A butter clarification system as in claim 1, wherein a packaging system is operatively connected to said butter clarification system to form sealed packages of clarified butter product.

9. The packaging system of claim 8, wherein said sealed package material comprises a high-temperature resistant film.

10. A method of forming clarified butter comprising the steps of:
heating butter to a melting temperature sufficient to separate a first layer of milk product, a second layer of butter-oil, a third layer of milk solids, and water;
agitating the melted butter to facilitate separation into the multiple layers from said butter;
removing said third layer of milk solids, and water; and
filtering said butter-oil through a first filter to remove particles larger than about 10 microns.

11. A method of forming clarified butter as in claim 10 above, further comprising the steps of, filtering the product from said first filtering step through a second filter to remove additional particles smaller than said first filter is capable of removing.

12. The method of claim 10, wherein processing said first layer comprises the optional step of pumping said first layer away from the top of said melted butter.

13. The method of claim 10, wherein said clarified butter is collected into a container.

14. The method of claim 10, wherein said clarified butter is machine-packaged using a high-temperature resistant film.

15. The method of claim 10, wherein said agitation is performed at between four (4) and ten (10) RPM.
